(19) United States
(12) Patent Application Publication
(10) Pub. No.: US 2005/0055236 A1
(43) Pub. Date: Mar. 10, 2005

(54) System and method for determining printing needs and implementing printing solutions

(75) Inventors: Christopher Bondy, Penfield, NY (US); David Blaszyk, Spencerport, NY (US); Christine Marie-Papp Balestra, Rochester, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/932,248

(22) Filed: Sep. 1, 2004

Related U.S. Application Data
(60) Provisional application No. 60/500,165, filed on Sep. 4, 2003.

(51) Int. Cl. G06F 17/60

(52) U.S. Cl. 705/1; 705/10

(57) ABSTRACT

A method for determining the printing needs of and for implementing print solutions for an entity includes the steps of analyzing a plurality of general records of a general list, each of the general records including general information regarding a corresponding entity, to thereby identify at least one entity having predetermined characteristics. The entities are stored as potential customer records in a business opportunity list. Specific information is obtained regarding the printing system and printing needs of the customer entity. The potential customer records and the corresponding specific information are evaluated to develop at least one proposed print solution for the customer entity. The solution is then implemented, tested, and supported.

### FIELD OF THE INVENTION

The present invention relates to a system and method for determining the printing needs of an entity, such as a business, and for implementing printing solutions that meet those needs.

### BACKGROUND OF THE INVENTION

Companies typically have a need to print or produce numerous and various types of documents, many of which are produced with the aid of one or more computers. The advances in computer and digital printing technologies have made it economical and convenient for many companies to produce in-house at least some of these documents, such as, for example, sales brochures, product literature and owners manuals, that would have heretofore required the services of a company devoted to and specializing in the production of such documents.

However, the pace at which printing and computer technologies have advanced has also created certain conditions that are less than ideal. Some companies are forced to operate with a printing infrastructure that includes patched-together equipment having different operating systems and/or protocols. Integrating relatively advanced or sophisticated printing and/or document-producing capability into such patched-together systems requires substantial knowledge and expertise. Further, many companies do not possess the knowledge or expertise to determine their printing and/or document producing needs, nor do they possess the knowledge of the various and myriad printing and/or document producing options that are currently available to them.

Therefore, what is needed in the art is a system and method by which the printing and/or document producing needs of a company are determined.

Moreover, what is needed in the art is a system and method by which solutions to those printing and/or document producing needs are identified and implemented.

### SUMMARY OF THE INVENTION

The present invention provides a system and method for use by a principal entity to determine the printing needs of and for implementing print solutions for use by a customer entity.

The present invention includes, in one form thereof, a method of determining and implementing a printing solution that includes the steps of analyzing a plurality of general records of a general list, each of the general records including general information regarding a corresponding entity, to thereby identify at least one customer entity having predetermined characteristics. The customer entities are stored as potential customer records in a business opportunity list. Specific information is obtained regarding the printing system and printing needs of the customer entity. The potential customer records and the corresponding specific information are evaluated to develop at least one print solution for the customer entity.

An advantage of the present invention is that the print solutions developed are stored and available for widespread dissemination within, for later reference and use by, and for commercialization to other customer companies by, the principal company.

A further advantage of the present invention is that issues in the development, integration, testing, and on-going use are recorded and incorporated into the process for identifying print solutions, thereby making previously-designed and implement solutions available to reduce the likelihood that effort and resources would be duplicated in the design and installation of similar systems.

### BRIEF DESCRIPTION OF THE DRAWINGS

The above-mentioned and other features and advantages of this invention, and the manner of attaining them, will become apparent and be better understood by reference to the following description of the embodiments of the invention in conjunction with the accompanying drawings, wherein:

FIG. 1 is a flow chart of one embodiment of the method of the present invention; and

FIG. 2 is a schematic representation of one embodiment of a system for performing the method of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DESCRIPTION OF THE PREFERRED EMBODIMENTS

The term printing needs as used herein includes pre-press, press and post-press activities related to printing. Pre-press activities include things such as, for example, job set-up, font and color selection, layout, image selection and positioning, etc. Press activities include the actual printing and paper handling for the printing process. Post-press needs include things such as, for example, finishing, binding, handling, and packaging for distribution.

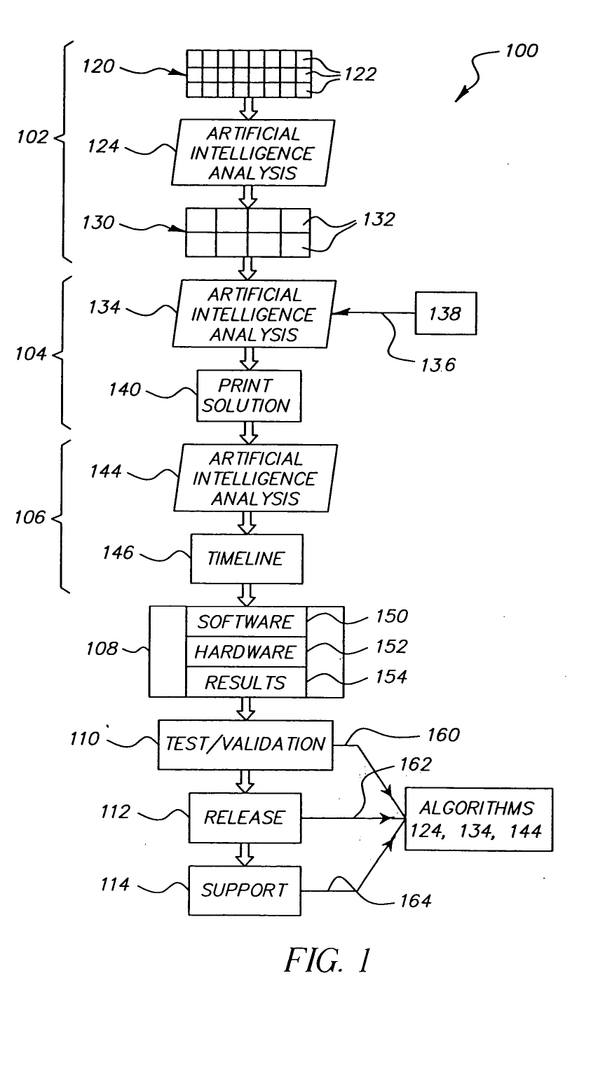

Referring now to the drawings, and particularly to FIG. 1, there is shown one embodiment of the method for determining printing needs and implementing printing solutions of the present invention. Method 100 is generally performed by, on behalf of, or in response to the request of a principal company, and includes identifying potential customers 102, identifying solutions step 104, implementation planning step 106, development and integration 108, test and validation 110, release 112 and support 114.

Identifying potential customers step 102 includes obtaining from various sources information regarding companies and/or other entities that may be potential customers of the principal company. General attributes of these potential customer companies are also acquired, such as, for example, address and general contact information. The information regarding these companies is collected into general list 120 that includes a plurality of general company records 122.

Each general company record 122 contains the name of a company/entity and its general information/attributes. Included as general records 122 of general list 120 are, for example, current and former customers of the principal company and other companies and/or entities that may be or appear to be involved in certain predetermined broad printing market segments, such as, for example, commercial printing, photofinishing services and/or transactional printing. Additional information, such as, for example, approximate size in terms of revenue and/or employees, volume of any printing services required and/or performed, type of technology employed and various other business and technical information regarding the potential customer companies is also obtained whenever possible. Thus, each general record 122 of general list 120 represents a potential customer company that may have some need for support, services and/or solutions related to digital printing that can be provided by the principal company.

General list 120 is then operated upon, such as, for example, by a set of rules-based questions and/or artificial-intelligence parameters 124, as part of identifying potential customers step 102 to thereby produce business opportunity list 130 which is a subset of general list 120. Business opportunity list 130 includes prospective customer (PC) records 132. PC records 132 include only those general records or companies 122 of general list 120 that satisfy or meet the criteria established by rules-based questions and/or artificial-intelligence analysis 124. Thus, PC records 132 represent the prospective customers that are contained within general list 120.

The rules-based questions and/or artificial intelligence analysis 124 includes questions and analysis that determine whether the particular customer company that is the subject of general record 122 produces printed material in sufficient volume or of sufficient complexity to require and/or benefit from a system produced by the principal company. Further, analysis 124 includes questions and analysis that determines from the information within general record 122 the current printing system architecture in use by the corresponding customer company and the type of work products produced to thereby determine whether the customer company requires or would benefit from the technology and/or support offered by the principal company. The types of printing/work product produced by a customer company are categorized into one of several broad categories including, for example, short run color, customized, personalized, versioned, transactional, fully custom, and automated fulfillment print output. Questions/analysis 124 are developed from a composite customer profile that contains the beneficial and/or desired attributes, such as technology and print volumes, of current, former and/or desired customers of the principal company. Business opportunity list 130 is input to, or is a resource for, identifying solutions step 104.

Identifying solutions step 104, in general, applies further rules-based questions and/or artificial-intelligence algorithm 134 to a selected PC record 132 in business opportunity list 130 to thereby determine what printing needs the potential customer may have. More particularly, each PC record 132 is individually analyzed and cross-referenced according to rules-based questions and/or an artificial-intelligence algorithm 134. Identifying solutions step 104 requires, and the questions/artificial intelligence algorithm 134 are applied to, information 136 regarding the particular company that is the subject of the corresponding PC record 132. Information 136 is obtained via completion of questionnaire 138, as is more particularly described hereinafter.

Information 136 generally pertains to the current system used by the particular customer company and includes, for example, profiles of key system users, print products that the system is used to create and the costs associated therewith, the operating environment of the system, the print floor configuration, and specific hardware, software and work processes employed within the system. Input/information 136 is collected through the completion of a questionnaire 138. Questionnaire 138 is completed either directly by or through input from a representative of the customer company. Questionnaire 138 is completed either on paper or electronically, such as, for example, via an electronic version of questionnaire 138 that is accessed via the Internet or distributed via e-mail. Rules-based questions and/or artificial-intelligence algorithm 134 is applied to each PC record 132 and the input/information 136 corresponding thereto, and produces one or more print solutions 140 for the review of and/or adoption by the customer company.

Rules-based questions and/or artificial-intelligence algorithm 134 produces one or more proposed print solutions 140. In order to do so, rules-based questions and/or artificial-intelligence algorithm 134 matches the information contained within PC record 132 and the input/information 136 corresponding thereto with one or more proposed print solutions 140. More particularly, artificial-intelligence algorithm 134 matches the required or expected volumes, type of printing, number of colors, types of bonding and/or paper processing required by the customer to the characteristics of various pieces of printing equipment and systems.

Each proposed print solution 140 includes a revised or new printing system architecture, a new or revised printing process model that illustrates the process, activities and high-level work flow of the proposed print solution 140, identification of new pieces of printing machinery that may be incorporated in the new printing process, and a new/revised printing work flow. Additionally, a customer information summary and other customer-focused information are generated by questions and/or artificial-intelligence algorithm 134.

Implementation planning step 106 utilizes yet another rules set and/or artificial-intelligence algorithm 144 to generate timeline 146 for the execution, implementation, installation and integration of a selected one of the proposed print solutions 140. Algorithm 144 creates timeline 146 based at least in part upon the complexity, elements and characteristics of the selected one of proposed print solutions 140, such as, for example, the system architecture, the particular pieces of printing and/or material handling equipment being installed and/or interfaced, etc. Once created, timeline 146 is circulated, such as, for example, electronically via e-mail or Internet, to and for the review of and approval by the various implementation teams involved in the actual installation of the desired/selected print solution 140. Once approved, the development and integration step 108 commences.

Development and integration step 108 includes the performance of a simulation using print systems simulation software 150, hardware 152 and/or a combination thereof that are created, selected and configured to reflect the printing system in use at the customer company location. Simulation software 150 and hardware 152 are used to conduct a simulation in order to discover any integration or other issues, such as, for example, protocol conflicts, that may arise when printing solution 140 is integrated into the printing system in use at the customer company location. Integration results 154 and/or other issues that arise or are discovered as a result of development and integration step 108, are addressed as part of the testing 110, release 112 and support 114 steps.

Test and validation step 110 tests print solution 140 in a controlled customer environment. Test results 160, such as, for example, potential reliability, functionality, and/or work flow issues, are fed back to and incorporated within one or more of artificial intelligence algorithms 124, 134 and 144, as appropriate.

Release step 112 includes the installation of print solution 140 at the customer location. The arrangement and characteristics 162 of print solution 140, which are at this point in the process fixed, are fed back to and incorporated within one or more of artificial intelligence algorithms 124, 134 and 144, as appropriate, and are available for future users of method 100 when seeking print solutions for other customer companies. Further, arrangement and characteristics 162 of print solution 140 is also available for other uses, such as, for example, marketing to other customers and/or full-scale commercialization.

Support step 114 includes the on-going gathering of feedback 164, which is also incorporated within one or more of artificial intelligence algorithms 124, 134 and 144, as appropriate. Feedback 164 includes data, such as, for example, the amount of use, indicators of the success and/or failure within the particular customer environment, the nature of use, suggested enhancements, and other customer feedback, that characterizes print solution 140 in use. Feedback 164 is also incorporated within one or more of artificial intelligence algorithms 124, 134 and 144, as appropriate.

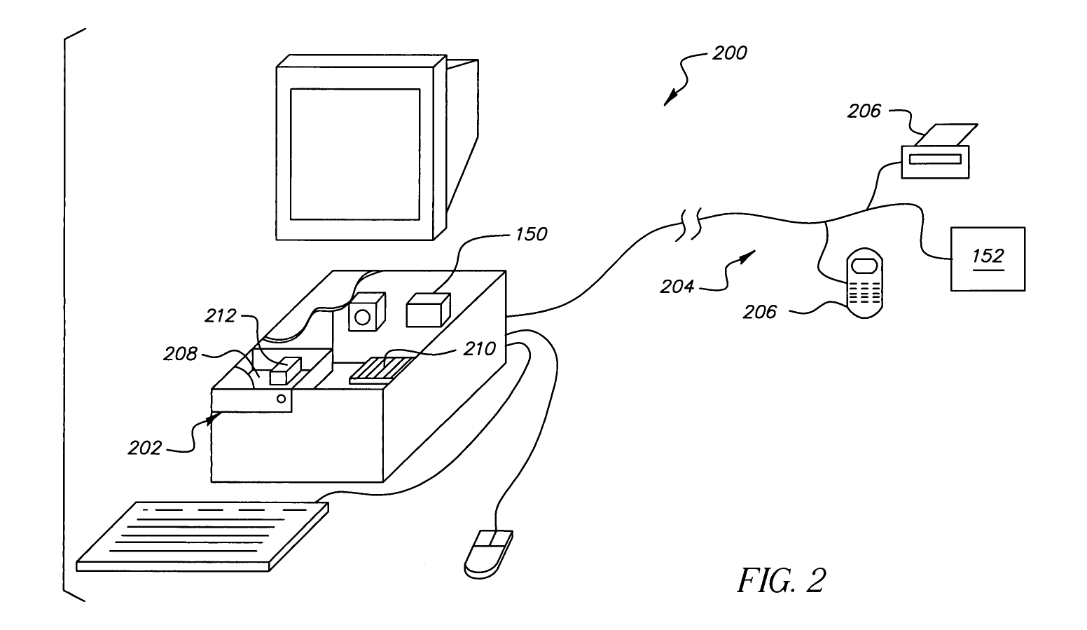

Referring now to FIG. 2, a schematic diagram of one embodiment of a system for performing the method of FIG. 1 is shown. System 200 includes at least one personal computer 202 that is connected to a computer network 204. Personal computer 202 communicates and exchanges data with a plurality of other electronic devices 206, such as, for example, printers, other computers, and personal digital assistants, via network 204. Further, computer 202 accesses the Internet and exchanges e-mail via network 204. Computer 202 includes data storage device 208, such as, for example, a hard drive, and memory 210 that includes random access memory and read only memory. The basic functions of personal computer 202, such as, for example, display and data handling, are controlled by an operating system (not shown). Computer 202 executes or runs application software 212 that embodies method 100, and which is stored in data storage 208.

In use, system 200 performs method 100. Computer 202 running application software executes identify potential customers step 102 by applying to general list 120 the rules-based questions and/or artificial-intelligence parameters 124 to produce business opportunity list 130. Business opportunity list 130, which includes a plurality of prospective customer (PC) records 132, is stored in one of storage device 208 and/or memory 210. PC records 132, as described above, include only those general records or companies 122 of general list 120 that satisfy or meet the criteria established by the rules-based questions and/or artificial-intelligence analysis 124. Thus, PC records 132 represent the prospective customers that are contained within general list 120.

Identifying solutions step 104 is then executed by system 200. More particularly, computer 202 analyzes one or more selected PC records 132 in business opportunity list 130 by applying artificial-intelligence algorithm 134 thereto. In doing so, computer 202 reads into memory 210, information 136 that corresponds to the particular PC record being analyzed. Information 136 is read from, for example, data storage device 208 or is requested and read from one or more remote electronic devices 206 over network 204. Algorithm 134 cross-references the information contained within PC record 132 and corresponding information 136, and produces one or more print solutions 140. Print solutions 140 are then stored in one of storage device 208 and/or memory 210, and can be printed, distributed to one or more intended recipients via e-mail, and/or posted to the Internet to be accessed by one or more intended persons or entities.

In order to arrive at print solutions 140, computer 202 executing application software 212 applies algorithm 134 to match the information contained within PC record 132 and the information 136 corresponding thereto, such as, for example, the required or expected volumes, type of printing, number of colors, types of bonding and/or paper processing required by the customer with the characteristics of various pieces of printing equipment and systems. Further, algorithm 134 analyzes the information contained within PC record 132 and the information 136 corresponding thereto with other, previously implemented, print solutions, to determine whether there is a match between any previously implemented print solutions and the customer needs represented by PC record 132 and information 136 corresponding thereto.

Implementation planning step 106 is then executed by system 200. More particularly, computer 202 executing application software 212 applies algorithm 144 to print solution 140 to generate timeline 146 for the execution, implementation, installation and integration thereof. Algorithm 144 analyzes the complexity, elements, and characteristics of the proposed print solution, such as, for example, the system architecture, the particular pieces of printing and/or material handling equipment being installed and/or interfaced, etc, to generate timeline 146. Once created, timeline 146 is printed and/or circulated electronically via e-mail, the Internet, or is accessed by other devices 206 over computer network 204, and is reviewed by the various implementation teams involved in the actual installation of print solution 140. Once approved by the teams, the development and integration step 108 is executed.

Similarly, development and integration step 108 is also executed by system 200. More particularly, computer 202 executing application software 212 executes development and integration step 108 by running print systems simulation software 150 which, in turn, interfaces with hardware 152 to simulate the operation of print solution 140 as it will be used in the customer environment. Simulation software 150 is, at least in part, developed for and is based upon a specific one of print solutions 140. Integration or other issues with the operation of print system 140 that occur during the simulation are recorded as integration results 154. Integration results 154 are recorded within one of storage device 208 and/or memory 210, and can be displayed on computer 202, printed, accessed via network 204 by devices 206, and/or distributed via e-mail to a desired destination. Application software 212 facilitates the review and analysis of integration results 154, which are fed back and incorporated into one more of artificial intelligence algorithms 124, 134 and 144, as appropriate.

Test and validation step 110, is then executed by computer 202 running application software 212 and print systems simulation software 150 to thereby test print solution 140 in a controlled environment. Test and validation step 10 issues test results 160 including less than desirable results and/or conditions, such as, for example, potential reliability, functionality, and/or work flow issues. Application software 212 facilitates the review and analysis of test results 160, which are fed back and incorporated into one more of artificial intelligence algorithms 124, 134 and 144, as appropriate. Test results 160 are, for example, configured as error codes and/or problem descriptions that are recorded within one of storage device 208 and/or memory 210, and can be printed, accessed via network 204 by devices 206, and/or distributed via e-mail to a desired destination.

Thereafter, release step 112 is executed. Print solution 140 is installed at the customer location, and the final design and characteristics 162 of print solution 140 are fed back and/or input into application software 212 and/or stored in storage device 208. Arrangement and characteristics 162 are then incorporated within one or more of artificial intelligence algorithms 124, 134 and 144, as appropriate. Print solution 140 is thereby incorporated within the knowledge base represented by application software 212 and algorithms 124, 134 and 144, and is thus available for reference and use by method 100 when a print solution is sought for other customer companies. Further, the final arrangement and characteristics 162 of print solution 140 are also available for other uses, such as, for example, marketing to other customers and/or full-scale commercialization.

Support step 114 includes the on-going gathering of feedback 164, which is also incorporated within one or more of artificial intelligence algorithms 124, 134 and 144, as appropriate, of application software 212. Feedback 164 includes data, such as, for example, the amount of use, indicators of the success and/or failure within the particular customer environment, the nature of use, suggested enhancements, and other customer feedback, that characterizes print solution 140 in use. Feedback 164 is gathered through various means, such as, for example, automated data collection and reporting, customer surveys completed and submitted via e-mail and/or over the Internet, and/or telephonic surveys. Feedback 164 is incorporated within one or more of artificial intelligence algorithms 124, 134 and 144, as appropriate, of application software 212.

While this invention has been described as having a preferred arrangement, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims

1. A computerized method for use by a principal entity to determine the printing needs of and for implementing print solutions for use by a customer entity, said method comprising:
analyzing a plurality of general records of a general list, each of the general records including general information regarding a corresponding entity, to identify at least one customer entity having predetermined characteristics;
storing the customer entities as a potential customer record in a business opportunity list;
obtaining specific information regarding the printing system and printing needs of the customer entity; and
evaluating the potential customer record and the corresponding specific information to develop at least one print solution for the customer entity.

2. The method of claim 1, wherein said general records include the type, technology, and volume of printing performed by the corresponding entities, said analyzing step comprises a first artificial intelligence algorithm executed by a computer and which identifies as customer entities those entities that perform printing of at least one of a particular type, predetermined range of volumes, or predetermined technology.

3. The method of claim 2, wherein the first artificial intelligence algorithm identifies as customer entities those entities of the general records that conduct at least one of photo-finishing, commercial printing, and transactional printing.

4. The method of claim 1, wherein said obtaining specific information comprises obtaining predetermined characteristics of the printing system in use at the customer entity, and associating the specific information with the corresponding potential customer records.

5. The method of claim 4, wherein said obtaining specific information comprises at least one of electronically distributing a questionnaire to the customer entity, and return by the customer entity of the completed questionnaire to the principal company, via one of e-mail, the Internet, and a computer network.

6. The method of claim 4, wherein said associating comprises one of reading the specific information into a memory or storing the specific information in a storage device of a computer.

7. The method of claim 1, wherein said evaluating step comprises a second artificial intelligence algorithm executed by a computer and which determines, dependent at least in part upon the potential customer record, at least one print solution.

8. The method of claim 7, wherein the artificial intelligence algorithm matches the potential customer record with, and the print solution includes at least one of, a printing system architecture, a printing process model, printing machinery to be incorporated in the printing process model, and a printing work flow.

9. The method of claim 1, comprising the further step of generating a timeline for implementation of the at least one print solution.

10. The method of claim 9, wherein said step of generating the timeline comprises a third artificial intelligence algorithm executed by a computer and which determines the timeline dependent at lest in part upon the characteristics and components of the print solution.

11. The method of claim 1, further comprising the step of developing and integrating the print solution by developing simulation software, executing the simulation software with a computer, the simulation software and computer being integrated with hardware identified by the print solution, and recording integration results.

12. The method of claim 1, comprising the further step of testing and validating the print solution, said testing and validating step issuing test results, said test results being fed back to and selectively incorporated within one or more of said first, second, and third artificial intelligence algorithms.

13. The method of claim 1, comprising the further step of releasing the print solution into use at the customer location and recording the final arrangement and characteristics of the print solution, the final arrangement and characteristics being fed back to and selectively incorporated within one or more of said first, second, and third artificial intelligence algorithms.

14. The method of claim 1, comprising the further step of supporting the print solution by gathering data in an on-going manner, said data including the amount of use of, indicators of success and/or failure of, nature of use of, suggested enhancements for, and customer feedback regarding the print solution, said data being fed back to and selectively incorporated within one or more of said first, second, and third artificial intelligence algorithms.

15. A system to determine the printing needs of and for implementing print solutions for a customer entity, said system comprising:
a personal computer having a display, at least one data storage device and a memory;
application software stored within at least one of said data storage device and said memory, and being executable by said at least one personal computer, said application software configured for analyzing a plurality of general records, each of the general records including general information regarding a corresponding entity, identifying customer entities having predetermined characteristics, storing the customer entities as potential customer records in a business opportunity list, reading specific information regarding the printing system and printing needs of the customer entity, and evaluating the potential customer records and the corresponding specific information to develop at least one print solution for the customer entity.

16. The system of claim 15, wherein said application software includes a first artificial intelligence algorithm that identifies as customer entities those entities that perform printing of at least one of a particular type, predetermined range of volumes, or predetermined technology.

17. The system of claim 15, wherein said application software includes a second artificial intelligence algorithm that determines, dependent at least in part upon the potential customer record, the at least one print solution.

18. The system of claim 15, wherein said application software includes a third artificial intelligence algorithm executed by a computer and which determines the timeline dependent at lest in part upon the characteristics and components of the at least one print solution.
